(19) United States
(12) Patent Application Publication
(10) Pub. No.: US 2025/0284838 A1
(43) Pub. Date: Sep. 11, 2025

(54) Data Pool for Unreliable Work Environments

(71) Applicant: Joshua Joseph Boutwell, Kathleen, GA (US)

(72) Inventor: Joshua Joseph Boutwell, Kathleen, GA (US)

(21) Appl. No.: 18/597,904

(22) Filed: Mar. 6, 2024

(51) Int. Cl. G06F 21/62; G06F 21/60

(52) U.S. Cl. CPC G06F 21/6227; G06F 21/602

(57) ABSTRACT

Methods and a system for a data pool which allows for local processing of database data and a server which is ignorant of data content and encryption keys for the database data. The data pool provides for local decryption and processing of data pool data, reducing security vulnerabilities and server load. The data pool also includes methods for creating an audit trail on a remote server of changes made to the data pool data locally so that in the event of an unexpected disconnection or shutdown of the local machine without uploading updated data, changes to the data pool data may be recreated on a subsequent use session with the local machine with minimal loss to changes or updates made in a previous session.

### FIELD OF THE INVENTION

The present invention relates generally to the field of databases. More specifically, the invention is in the subfield of end-to-end encrypted databases.

### BACKGROUND OF THE INVENTION

Databases are frequently used by individuals, businesses, or groups of people to allow for a centralized repository of large amounts of data that may be viewed, downloaded, or manipulated. Many databases are also connected to the internet or otherwise electronically accessible from a remote location to allow a user to access the database remotely. These remotely accessible databases are often targets for hackers, unauthorized users, or other bad actors who may wish to gain access to the database and sensitive data contained within it. As a result, several security measures are routinely implemented in existing databases in an attempt prevent hacking or unauthorized access to the database data while still allowing for remote access. However, existing security techniques are often cumbersome, slow the use of the database, and require intensive use of server resources, increasing user costs. Furthermore, such databases are particularly vulnerable to the loss of data in work environments where the connection between the local machine and server is not consistent or where it may be severed. As such, there is a need in the art for a database system or data pool with increased security, potentially reduced computing and server costs, and which may work reliably and minimize the loss of data in unreliable work environments.

### SUMMARY OF THE INVENTION

An aspect of an embodiment of the present invention provides for methods and a system to implement a secure data pool with end-to-end encryption. The data pool comprises a system wherein the data pool data is encrypted and stored on a remote server that is never in possession of, nor has access to any of the encryption keys required to decrypt and access the data pool data. Furthermore, the data located on the remote server is genericized in that the sectioned or chunked data is organized such that individual data chunks are not distinguishable from one another so that data chunks which may allow for access to the data pool data cannot be determined by an outside hacker, unauthorized user, or bad actor.

The data pool may comprise an encrypted key vault for controlling access to the data pool, a primary chunk that contains the database schema and registry or organizational information about the data pool, and a plurality of data chunks that contain the data pool or database data. The data pool may also use a local machine for most data processing, such that load on the remote server is reduced, allowing for faster and lower cost processing of data pool data. The data pool may also comprise methods for creating a linked list audit chain of changes to the data pool so that changes to the data pool data which are made locally are frequently uploaded to a server. This audit list, comprised of a series of interim packages, allows for small, quickly transmitted packages to be sent from the local machine to the server such that in the event of an unexpected or unplanned disconnection or shut down of the local machine, a record of changes exists on the remote server which can be processed at a later date to recover changes or data that otherwise would be lost in traditional data pool or database systems.

### DESCRIPTION OF THE DRAWINGS

The accompanying drawings, which are incorporated into and form a part of the instant specification, illustrate several aspects and embodiments of the present invention and, together with the description herein, serve to explain the principles of the invention. The drawings are provided only for the purpose of illustrating select embodiments of the invention and are not to be construed as limiting the invention.

FIG. 1 provides a block diagram of an exemplary embodiment of a secure personal data pool.

FIG. 2A provides a flowchart of an exemplary embodiment of a method for setting up or establishing a personal data pool.

FIG. 2B provides a flowchart of an exemplary embodiment of a method for operating a personal data pool.

FIG. 3A provides a schematic depiction of an exemplary embodiment of the data structure of a key vault in a personal data pool.

FIG. 3B provides a schematic depiction of an exemplary embodiment of the data structure of a prime chunk in a personal data pool.

FIG. 3C provides a schematic depiction of an exemplary embodiment of the data structure of a data chunk in a personal data pool.

FIG. 3D provides a schematic depiction of an exemplary embodiment of the data structure of an interim package in a personal data pool.

FIG. 4 provides a flowchart of an exemplary embodiment of a method for setting up or establishing a personal data pool.

FIG. 5 provides a flowchart of an exemplary embodiment of a method for starting and querying a personal data pool.

FIG. 6 provides a flowchart of an exemplary embodiment of a method for modifying data in a personal data pool.

FIG. 7 provides a flowchart of an exemplary embodiment of a method for rebuilding lost data in a personal data pool.

### DETAILED DESCRIPTION OF EXEMPLARY EMBODIMENTS OF THE INVENTION

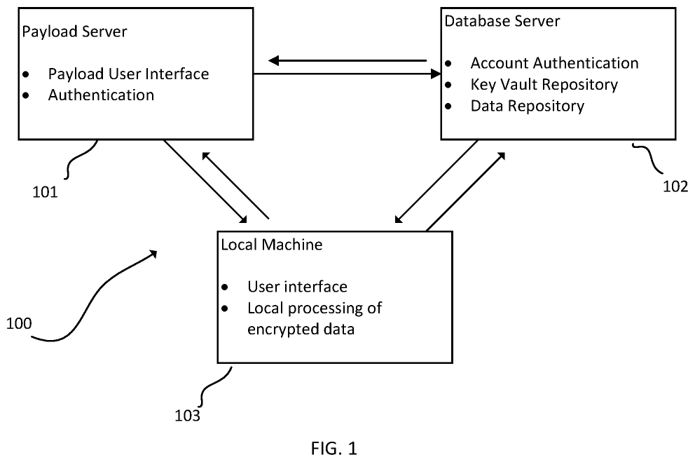

FIG. 1 provides a block diagram of an exemplary embodiment of the structure of a personal data pool 100 for use in unreliable environments. The personal data pool 100 system may comprise a database server 102 in electronic communication with a payload server 101 and a local machine 103. The data pool 100 may be adapted for use in environments where the components of the data pool 100 may lose connection with one another due to interruptions of service, unexpected shutdowns, or other events which may cause the loss of data or communication between the payload server 101, database server 102, local machine 103, or any combination thereof.

The personal data pool 100 may divide the functions of the overall system among its constituent parts to both provide for extra security of database data, for more economical processing of database data, or for ease of access and use of the personal data pool 100. For example, the personal data pool 100 may comprise a database server 102 which may provide account authentication, storage of a key vault, primary chunk, or both, and storage of the database data. It should be appreciated that the data pool 100 may also function such that the storage of the database data is done on a separate server that is nether the payload server 101 or the database server 102. A payload server 101 may provide a payload user interface, such as an overlying software that functions on top of the personal data pool 100 and may provide for authentication of the user after the initial account authentication. A local machine 103 may then run software on the personal data pool 100 which allows for a remote instance of the database controlled by the personal data pool 100 to be accessed and manipulated by a user. For example, the local machine 103 may run a web assembly module to operate an SQLite database that functions on the personal data pool 100. However, it should be appreciated that the local machine 103 may run any type of software that allows the local machine 103 to interact with the database server 102, payload server 101, or both. This software may be cloud based, or installed directly on the local machine 103. The local machine 103 may then access and manipulate data from the personal data pool 100 without the need to install any specialized software or programs to the local machine 103, allowing for secure database access from any location. Furthermore, the local machine 103 may provide the processing of the data on the personal data pool 100 necessary to encrypt, decrypt, or manipulate database data such that the database server 102 and payload server 101 will never need, nor have, any access to the encryption keys which allow for decryption, viewing, and use of the database data on the personal data pool 100. Rather, the database server 102 and payload server 101 serve only to store data of the personal data pool 100 and to provide authentication and a user interface for the local machine 103 of the personal data pool 100. It should be appreciated that in certain embodiments, the personal data pool 100 may not require a separate payload server 101 and database server 102, but rather a single server providing all the functions of the payload server 101 and database server 102 may be used. In still further embodiments, the functions of the payload server 101 and database server 102 may be split among any number of machines in the personal data pool 100. It should be appreciated that the payload server 101, database server 102, local machine 103, or any other electronic devices connected to or within the personal data pool may comprise any type of electronic device including, but not limited to, computers, servers, cellular phones, smart phones, tablets, or other devices which may connect to and communicate through the internet or other electronic means.

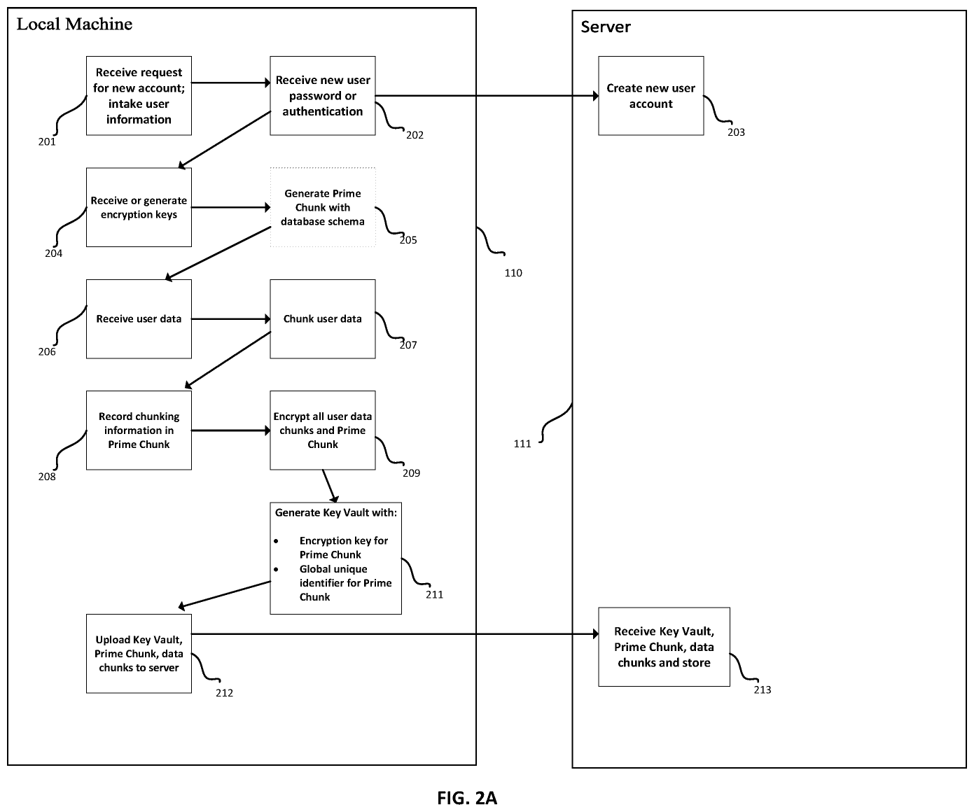

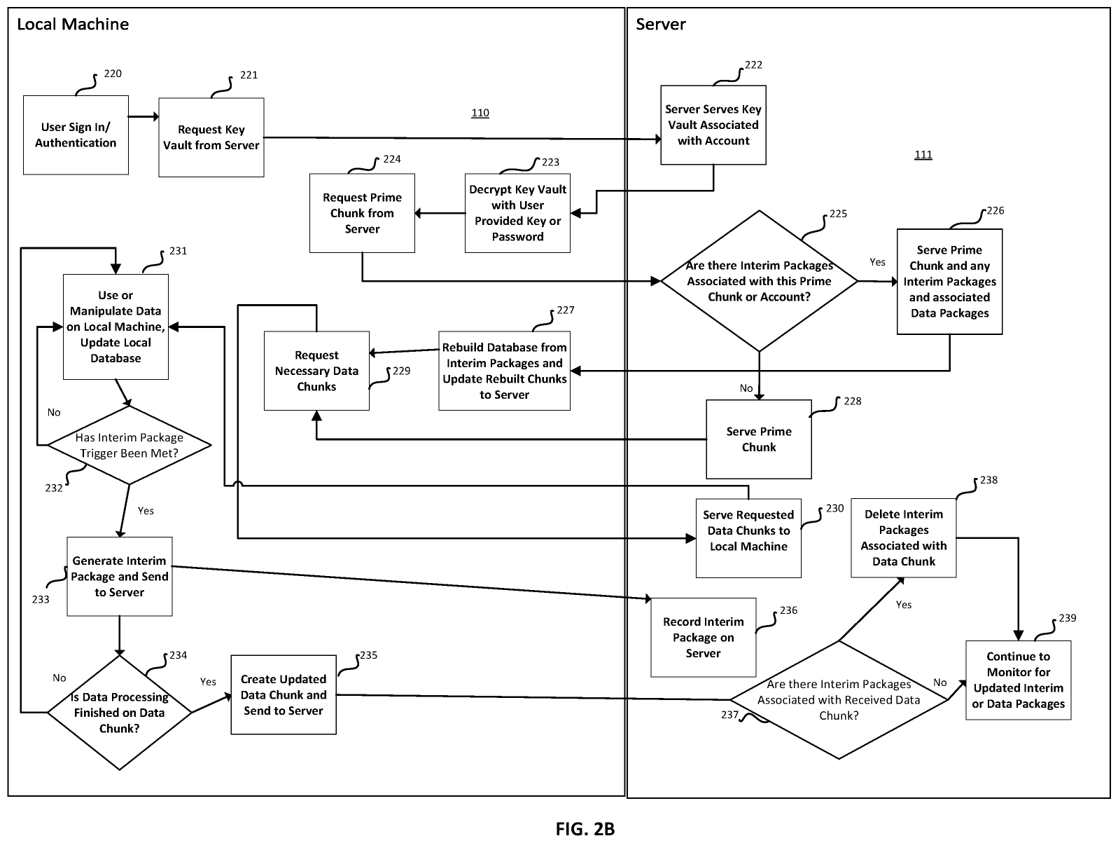

FIG. 2A provides a flowchart of an exemplary embodiment of a method for establishing a personal data pool with a local machine 110 and a server 111 and the interaction between a server 111 and a local machine 110. The establishment of a personal data pool may begin with an act 201 of receiving a request for a new account and receiving user information on the local machine 110. The method may then comprise an act 202 of receiving or otherwise requesting a new user password or other method of authentication on the local machine 110. The local machine 110 may then send this input information to the serve to create a new account at 203. The local machine 110 may then receive one or more encryption keys from the user or generate them through one of any number of encryption key methods at 204. For example, the local machine 110 may hash, salt, or otherwise process the user's password to create one or more encryption keys for use on the personal data pool. The local machine 110 may then generate a prime chunk with the database schema and other information regarding the database at 205. Once the database schema and prime chunk have been established at 205, the local machine 110 may receive the user data at 206. The user data may then be split into one or more data chunks based on chunking rules at 207. It should be appreciated that any number of chunking rules may be used to define how data is divided into the requisite number of data chunks. In certain embodiments, the data should be divided into data chunks such that data that is frequently associated or used together is contained within the same data chunk where possible. While the data may be chunked in any variety of ways, one exemplary method for data chunking is to first chunk data horizontally such that data which is frequently used or updated together is present in the same chunk. If the amount of associated data is larger than the maximum chunk size permitted in the personal data pool, then the data may be further chunked vertically for multiple data chunks to be associated together with the same type of data or data that is often used or updated together.

Still referring to FIG. 2A, once the data has been divided into data chunks, the record of those chunks, including their global unique identifier and encryption keys may be recorded in the prime chunk at 208. The local machine 110 may then encrypt all of the user data in the data chunks established at 207 and encrypt the prime chunk at 209. The local machine 110 may then generate a key vault at 211. The key vault is a unique portion of the personal data pool which holds the encryption key, location, and global unique identifier for the prime chunk, which itself holds the database schema, locations, and encryption keys for the data chunks. The local machine 110 may encrypt the key vault with a key provided by the user or a key that is generated by the personal data pool software from some user input, such as a password or other unique data that is not shared with the server 111. Once the key vault is encrypted, the local machine 110 may upload the key vault, prime chunk, and all data chunks at 212 and they may be received by the server 111 and stored at 213.

FIG. 2B provides a flowchart depicting an exemplary embodiment of a method for operating the personal data pool and the interaction between a local machine 110 and a server 111 on the personal data pool. The process may start with the sign-in or authentication of a user at 220 and a request from the local machine 110 for the key vault at 221. The server 111 may then serve up the key vault associated with the account at 222. It should be appreciated that because the key vault is encrypted with a key that is provided by the user or generated on the local machine 110, the server 111 is never in possession of the key to the key vault, and thus cannot determine which data chunk is the prime chunk of the personal data pool. The data in the personal data pool is then more secure and resistant to hacking or other malfeasance because only the local machine 110 may access the personal data pool data. Should the server 111 be hacked or otherwise attacked and the data stolen by a bad actor, it cannot be decrypted without the encryption keys that are not present on the server 111. Furthermore, in certain embodiments, the personal data pool data may be public on the server 111, or the server 111 may serve up the key vault without authentication, because the user-provided key to decrypt the key vault, which then allows for access to the personal data pool data, may serve as a security method to prevent unauthorized access to the personal data pool data. Thus, the personal data pool data may even be located in a public or unsecure environment and still be secure and unusable for anyone except the personal data pool owner or authorized user. Still referring to FIG. 2B, the local machine 110 may then decrypt the key vault with an encryption key that is either provided by the user or derived from some user input, such as the user's password at 223. Once the key vault is decrypted, the local machine 110 may then use the global unique identifier for the prime chunk in the key vault to request the prime chunk from the server 111 at 224. The server 111 may then query whether or not there are any interim packages associated with the personal data pool at 225. If there are interim packages present, then the server 111 may serve up the prime chunk along with any interim packages and their associated data chunks at 226. The local machine 110 may then rebuild any lost data on the personal data pool at 227 using the interim packages and their associated data chunks. After the local machine 110 has completed the rebuild of lost data at 227, it may proceed to 229 and request any necessary data chunks for the personal data pool.

If the server 111 had determined that there were not any interim packages associated with the personal data pool at 225, the server 111 may then serve up the prime chunk at 228, and then local machine 110 may then request any necessary data chunks at 229. In response to the request for data chunks at 229, the server 111 may serve the requested data chunks to the local machine 110 at 230. The local machine 110 will now have the necessary data chunks to manipulate, update, or otherwise use the required data from the personal data pool at 231. While working on the personal data pool data, the local machine 110 may monitor the work on the data chunks to determine if a requirement for an interim package has been triggered at 232 for any particular data chunk. It should be appreciated that the personal data pool may set rules or triggers for the production of interim packages. For example, the software may trigger the production of an interim package in response to a particular act, such as the completion of a defined task that establishes a recovery point, in response to a user request, based on a timed trigger, or any combination thereof. Furthermore, either the personal data pool software or the payload software which works on top of the personal data pool may establish any number of triggers or rule sets for creation of interim packages. It should be appreciated that the interim package recovery point trigger may be based on a recoverable stable state of the database as a whole such that once applied, the whole database will be consistent based on the specific requirements or work flow of any payload software that works with or on top of the data pool.

If no trigger for the creation of interim packages has been tripped, the software will continue to monitor for trips at 231. If a trigger trips, the personal data pool may then generate an interim package and send it to the remote server 111 at 233. Interim packages, which represent an audit trail of changes to the data chunks of the personal data pool, are typically small in size and are easily and quickly sent from the local machine 110 to the server 111 for storage. Upon receipt, the server 111 may then record the interim packages and store them at 236. Once the interim packages have been sent, the local machine 110 may then monitor whether or not data processing has completed on any particular data chunk at 234. If data processing has not finished on a particular data chunk, the system will continue to monitor for updates, changes, or other work done on that data chunk at 231. If, however, data processing has been completed on a particular data chunk, the local machine 110 may create an updated data chunk and send it to the server 111 at 235. Upon receipt of the updated data chunk, the server 111 may then query whether or not there are any interim packages associated with the received data chunk at 237. If there are interim packages associated with the data chunk, then the server 111 may delete that chain of interim packages at 238 and then continue to monitor for receipt of interim packages or data chunks at 239. If there are no interim packages detected at 237, then the server 111 may continue to monitor for updated interim packages or data chunks at 239. It should be appreciated that during this process, the server 111 is never in possession of any encryption key which could be used to access the data in the personal data pool. All processing of the data and decryption of the data is done on the software running on the local machine 110, which may exist only in the random access memory of the local machine 110, preventing hacking or unauthorized access to the personal data pool data. Furthermore, no permanent record of the personal data pool data will be present on the local machine 110 after the user exits the program. In certain embodiments, all of the processing of the personal data pool data is done on a local machine 110 in temporary memory, and the server 111 only provides a repository of the encrypted data with no keys or other methods of decrypting the data present on the server 111. In the event of a hack or unauthorized access to the server 111, the data will not be useable to a bad actor.

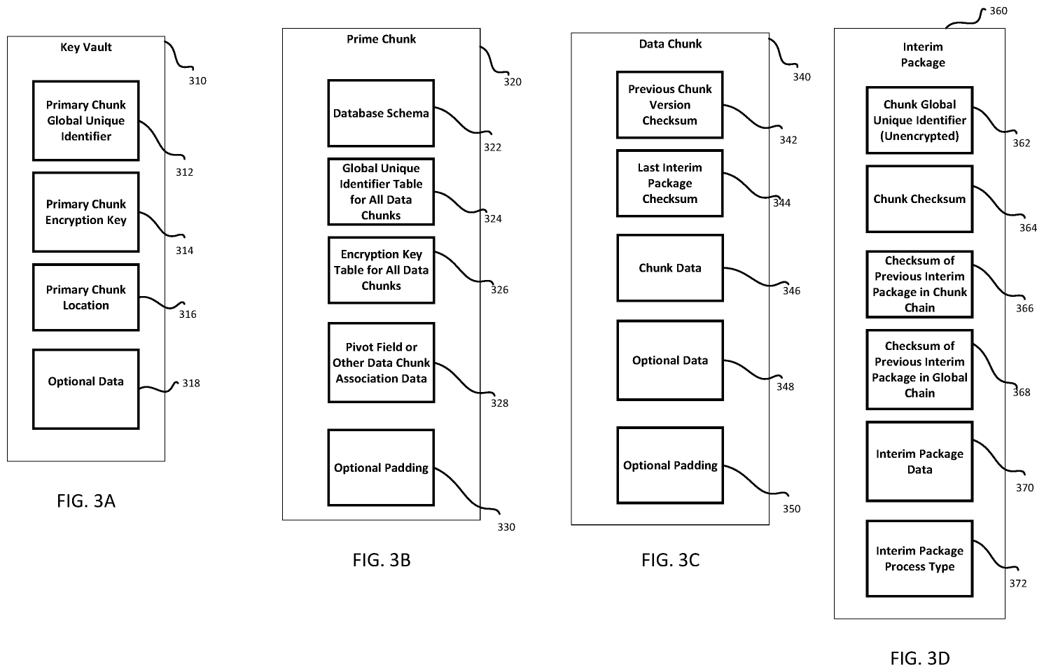

FIG. 3A provides a schematic depiction of an exemplary embodiment of the data structure of the key vault 310 of the personal data pool. The key vault 310, which serves as the access key for the personal data pool and provides a layer of security that prevents unauthorized use of the personal data pool, may contain a variety of data fields. For example, the key vault 310 may contain the global unique identifier for the primary chunk 312 to the personal data pool. The key vault 310 also may contain the encryption key for the primary chunk of the personal data pool 314. The key vault 310 may also contain the location of the primary chunk within the personal data pool 316. Other optional data 318 may also be held within the key vault 310, depending on the payload software which operates on or with the personal data pool, and is dependent on the particular implementation of that payload software and the personal data pool. This data structure allows the key vault 310 to effectively work as a physical key in allowing or denying access to the primary chunk, and thus the data on the personal data pool.

FIG. 3B provides a schematic depiction of the data structure of a prime chunk 320 of the personal data pool. The prime chunk 320 may include a number of fields of data including the database schema 322, a table of the global unique identifiers of all the data chunks on the personal data pool 324, a table of the unique encryption keys for each data chunk on the personal data pool 326, and a pivot field or other data chunk association data 328. This pivot field or other data chunk association data 328 allows the local machine to determine which data chunks are most relevant and needed to carry out a particular operation, allowing the local machine to work more efficiently by only downloading a portion of the data stored on the personal data pool at any one time. The prime chunk 320 may also include padding data 330 to give all chunks on the personal data pool, such as the prime chunk 320 and the data chunks, the same overall data size. This may help to mask the prime chunk 320 from other data chunks on the personal data pool increasing security. It should be appreciated that the prime chunk 320 may also include additional fields or data that is dependent on the implementation of the personal data pool, the payload software, or both.

The prime chunk 320 serves as a catalog or listing of all the data on the personal data pool. While the key vault 310 provides the personal data pool with security and provides access to the prime chunk 320, the prime chunk 320 serves as the directions or instructions to access and use the personal data pool. The prime chunk 320 allows the local machine to know where the individual data chunks are located, how they are related to one another, and the encryption keys for each data chunk. With this information, the local machine can convert what would otherwise be random data located on a server into useful, unencrypted data that may be viewed, processed, or manipulated locally.

FIG. 3C provides a schematic depiction of a data chunk 340 on the personal data pool. The data chunk 340 may include a number of fields or types of data including the checksum of the previous version of this data chunk 342, the checksum of the last interim package associated with this data chunk 344, and the data held within the data chunk 346. The data chunk 340 may also contain optional data 348 that may be selected or included based on the particular implementation of the personal data pool or the payload software, and it may also contain optional padding 350 to ensure that all data chunks 340 on the personal data pool are of the same size and therefore indistinguishable from one another to an outside observer or potential hacker or bad actor.

The fields of the data chunk 340 also allow for providing a string of data that may help in the reconstruction of data or error proofing the personal data pool when it is operated in an unreliable environment. For example, the checksum of the previous version of the chunk 342 allows for associating the current data chunk 340 with the previous version of this data chunk and may serve as an indicator of the data chunk version that is being worked on. The field for the previous version of the data chunk 342 can be used as a linked list to see or determine the chain of data chunks for a particular global unique identifier. Similarly, the field for the last interim package checksum 344 allows for the creation of a change audit log as it allows for identification of the last interim package associated with the data chunk 340, and thus can help to create an audit log of changes that may be applied if the data chunk 340 is not successfully uploaded to the server. In certain embodiments, the last interim package checksum 344 may provide an authoritative cutoff for the interim package chain during rebuild. It should be appreciated that any interim package 360 that precedes the last interim package checksum 344 is an interim package that would be applied to a previous version of the data chunk 340 and should not be applied to the current version of the data chunk 340 during rebuilding of data.

FIG. 3D provides a schematic depiction of the data structure of an interim package 360 on the personal data pool. The interim package 360 serves the function of uploading changes made to data chunks 340 on the local instance of the personal data pool which may then be quickly and easily uploaded to the server as they are typically smaller in size than a data chunk 340. The interim package 360 may include a number of fields or types of data that allow the interim package 360 to record changes to its associated data chunk 340 and to provide a linked list record of changes to the data chunk 340 for rebuilding or reconstitution of the data chunk 340 in the case of an unwanted or unexpected disconnection or shutdown of the local machine before the data chunk 340 may be uploaded to the server.

Still referring to FIG. 3D, the interim package 360 may include the global unique identifier of the data chunk 340 that it is associated with or applied to 362. This data chunk global unique identifier 362 may not be encrypted as it allows the server to perform the function of listing which data chunks 340 have associated interim packages 360 for serving to the local machine for processing and rebuilding of data. The data chunk global unique identifier 362 also allows the local machine to determine which encryption key will decrypt the interim package 360 because an interim package 360 is encrypted with (and subsequently decrypted with) the same encryption key used on the associated data chunk 340. The local machine may then refer to the primary chunk 320 for the appropriate encryption key based on this data chunk global unique identifier 362. It may also include the checksum 364 of the data chunk 340 which it is associated with and the checksum 366 of the last interim package associated with that data chunk 340. By including the checksum 366 of the last interim package associated with that data chunk 340, a linked list of the changes to the data chunk 340 is created and the personal data pool system may then use this linked list of checksums 366 of the previous interim package associated with a particular data chunk 340 to recreate changes made to that data chunk 340. The interim package may also include the checksum 368 of the last interim package created by the personal data pool regardless of which data chunk 340 that previous interim package 360 was associated with. This allows for the recreation of a global linked list of all interim packages 360 that have been created by the personal data pool for all data chunks 340. The interim package 360 may also include fields for the interim package data 370, which defines the changes made to the data chunk 340, and the interim package process type 372 defining the type of process or manipulation that created the change in the data chunk 340. It should be appreciated that the interim package 360 may also include other fields or types of data which may be selected or included based on the particular implementation of the personal data pool or the payload software which may interact with the personal data pool.

Referring to FIGS. 3A-3D, it should be appreciated that the key vault 310, prime chunk 320, data chunk 340, and interim package 360 may all have additional information or data fields that are not encrypted and are accessible to any user. For example, the key vault 310, prime chunk 320, data chunk 340, or interim package 360 may include a global unique identifier that is unencrypted, or they may include a checksum of the encrypted data that allows the server to perform organizational functions such as associating interim packages 360 with data chunks 340 or serving up a particular requested data chunk 340 when requested by the local machine. However, it should be appreciated that the checksum of the encrypted data for the key vault 310, prime chunk 320, data chunk 340, or interim package 360 may be calculated from the encrypted data directly by the server without any input from the local machine or any requirement for the checksum to be provided to the server.

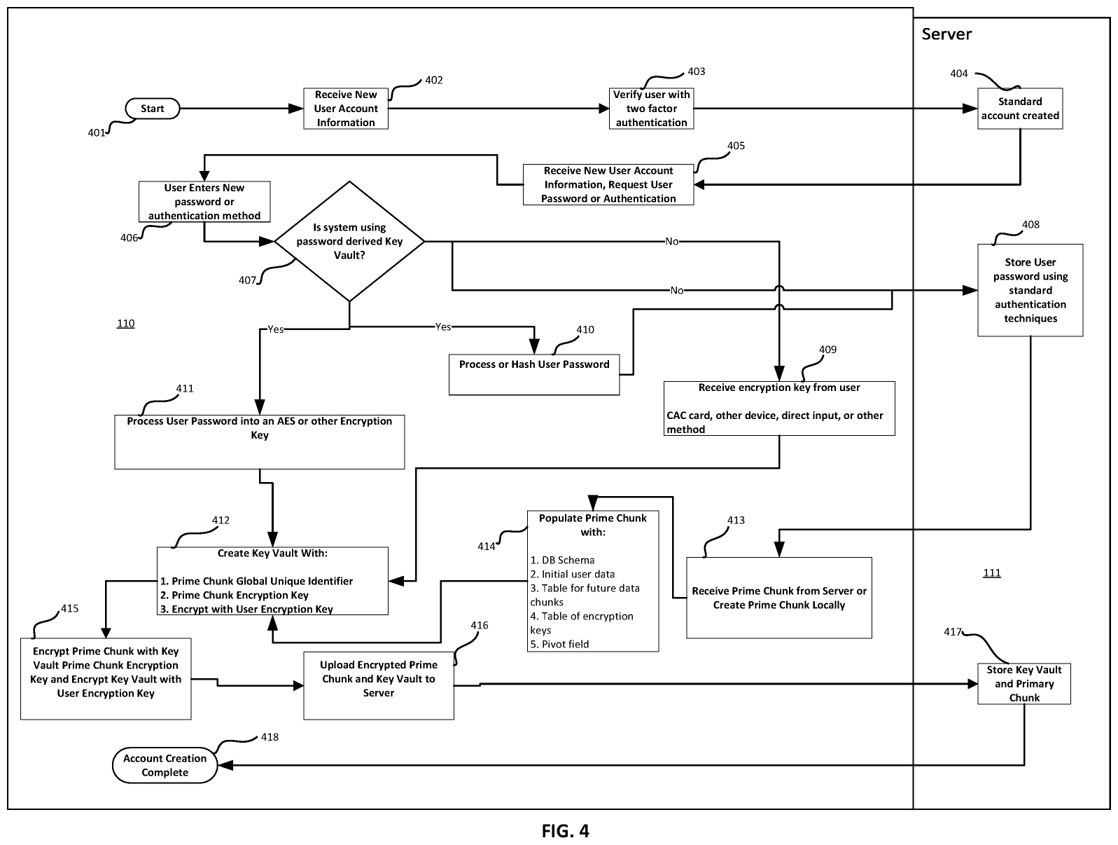

FIG. 4 provides a flowchart of an exemplary embodiment of a method for setting up or establishing an instance of the personal data pool for a user. The process for setting up the personal data pool may start at 401 with some signal or instruction received by a local machine 110 to set up an account with the personal data pool server 111. The local machine 110 may then receive user information such as a username, password, or other account information at 402. The system may then optionally require two factor authentication from the user at 403. It should be appreciated that any method of two factor authentication may be used to verify the creation of a new account. Once the local machine 110 has initiated the account creation and verification process, the server 111 may then create a standard account for the user at 404. The server 111 may then send this information to the local machine 110, and the local machine 110 may receive that information and request a password or other method of authentication from the user at 405. The local machine 110 may then receive the new password or other method of authentication at 406. The local machine 110 may then query whether or not the system will be using a password derived encryption key for the key vault at 407. If not, the local machine 110 may send the user password to the server 111, which may then store that password for future authentication at 408. The local machine 110 may then receive an encryption key from the user at 409. It should be appreciated that the local machine 110 may receive the encryption key in any variety of ways, such as if a user provides an encryption key with a device, a CAC card, or by directly entering the encryption key into the local machine 110 at 409. If the user password will be used to derive an encryption key for the key vault, then the local machine 110 will hash or otherwise process the user password at 410 and send this processed or hashed password to the server 111 for storage at 408. It should be appreciated that this processing or hashing of the user's password at 410 and then sending the processed or hashed password for storage on the server 111 at 408 means that the server 111 may verify or authenticate the user without having any access to the password based encryption key that may decrypt the key vault. On subsequent logins for a user, the local machine 110 may receive the user password, hash or process the password, and then send that processed or hashed password to the server 111 for authentication. Because the server 111 does not have the original password, and because the processing or hashing of the password is a one-way function in that the resulting processed or hashed password cannot be processed back into the original password, the server 111 may authenticate by matching the originally processed and hashed password value to the one provided by the local machine 110 on a subsequent login, but it will not have access to the password string that was used to create the key vault encryption key.

Still referring to FIG. 4, the local machine 110 may use the user's password and process or hash it into an AES or other encryption key at 411. It should be appreciated that the personal data pool system may use any method or process for converting the user password string into an encryption key for the key vault, and the personal data pool may function as desired regardless of the processing or hashing method chosen. The local machine 110 may then either request a generic prime chunk from the server 111 or generate one locally at 413 and populate the prime chunk with the database schema, a table for the listing of data chunks, a table for the encryption keys of the data chunks, and pivot fields or data chunk association data at 414.

Once the local machine 110 has a preliminary prime chunk from 414 and the encryption key for the key vault, either from processing with the user password at 411 or from some other password source at 409, the local machine 110 may then create a key vault with fields for the global unique identifier for the prime chunk, prime chunk encryption key, and prime chunk location and encrypt the key vault at 412. The local machine 110 may then encrypt the prime chunk with the prime chunk encryption key listed in the key vault at 415. It should be appreciated that the key vault and prime chunk may be encrypted in any order, so long as the prime chunk and key vault are encrypted before upload to the server at 416. Upon completion of encryption of the key vault and prime chunk, the local machine 110 may then upload the encrypted prime chunk and key vault at 416, and the server 111 may store the key vault and prime chunk at 417. The account creation process on the local machine 110 is now complete at 418 and the local machine 110 may shut down, log out, or otherwise continue with by receiving data or other information from the user. It should be appreciated that in some embodiments, the user may immediately upload information into the personal data pool through the local machine 110, and the local machine 110 may divide that information into data chunks for immediate upload to the sever. Data may be chunked in any way applicable to a particular implementation of the personal data pool or the payload software. In certain embodiments, the personal data pool may chunk data horizontally and vertically. For example, horizontal chunking of data attempts to place data that is frequently updated or used together into the same data chunk so that the local machine 110 may download fewer data chunks from the server 111 and still have all the necessary data for its processing needs. However, in certain embodiments, the amount of data that may be horizontally chunked may exceed the set data chunk size limits. In this case, the data may then be vertically chunked such that the related data is then distributed among various related data chunks that are associated with one another to bring the required data within the specified data chunk size. It should be appreciated that the data chunk may be sized as desired or required for a particular application of the personal data pool, payload software, hardware it is intended to run on, or any combination thereof.

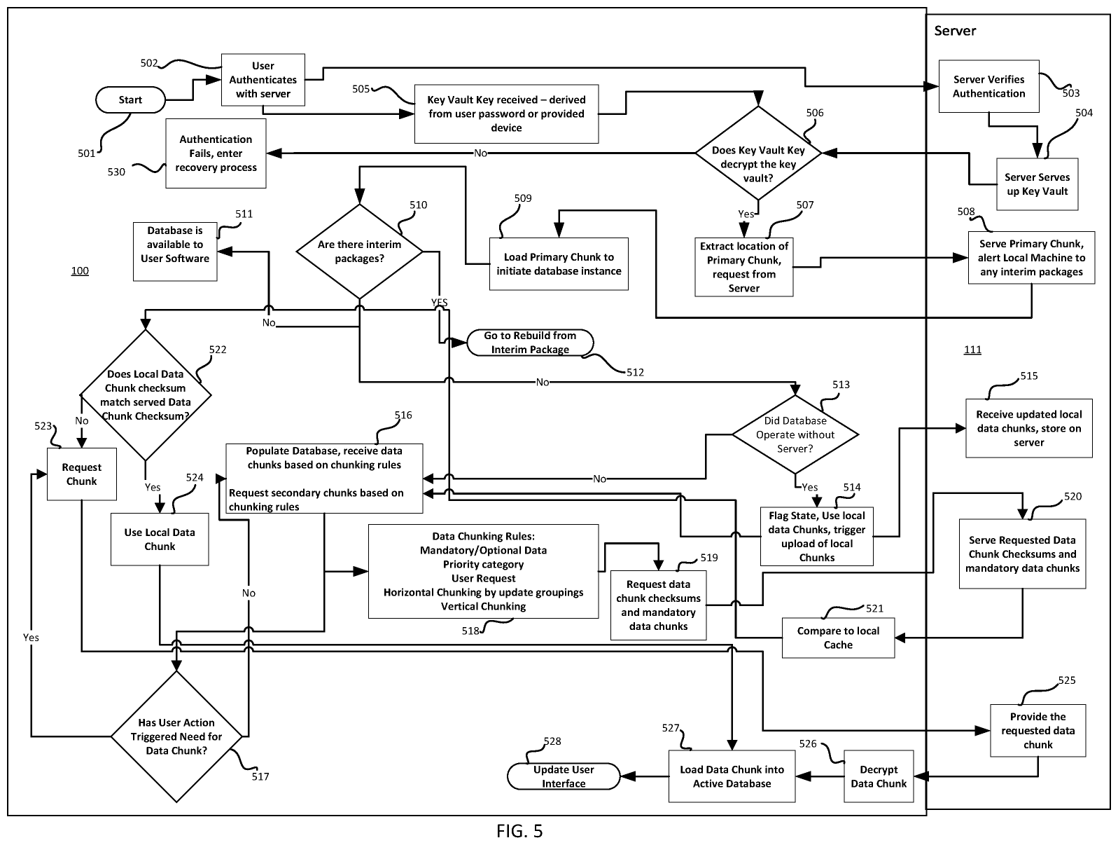

FIG. 5 provides a flowchart of an exemplary embodiment of a method for starting and querying an established personal data pool and the interaction between a local machine 110 and a server 111. The personal data pool session may begin with the local machine 110 receiving a start signal at 501, such as a user directing the local machine 110 to a website or other action that will connect the local machine 110 to one or more personal data pool servers 111. The local machine 110 will then intake some form of user authentication at 502 and send this authentication to the server 111, which the server will verify at 503 and then serve up the key vault at 504. The local machine 110 will also receive an encryption key from the user at 505. In this step, the encryption key may be derived from the user's login password, another user input, or may be provided by a device or directly typed in by the user such that the local machine 110 now has an encryption key to attempt to decrypt the served up key vault at 506. If the user-provided key does not decrypt the key vault and authentication fails, the local machine 110 may move to enter a recovery process at 530. It should be appreciated that this recovery process may take on any number of operations including, but not limited to, requesting the user resubmit the decryption key, shutting down the system, locking the user out of the system, restarting the system, or any other operation as desired or required for a particular implementation of the personal data pool, payload software, or both.

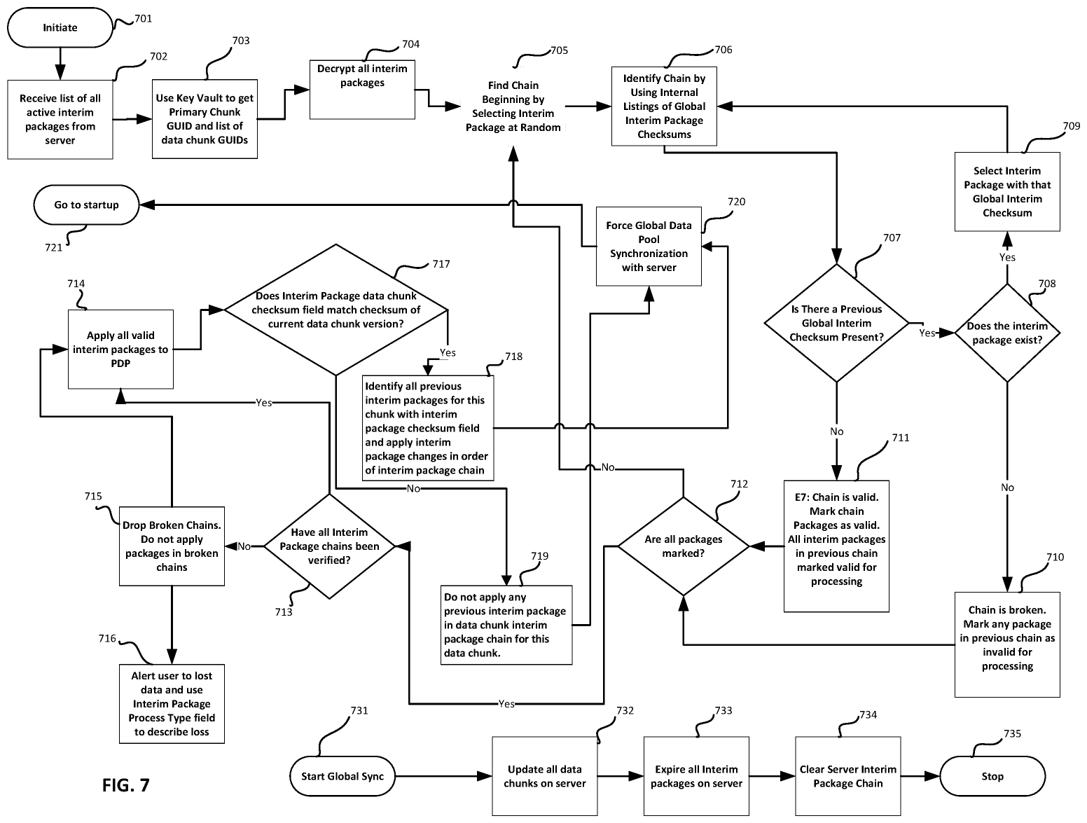

If the user-provided encryption key does decrypt they key vault, the local machine 110 may extract the location of the primary chunk at 507 and request the primary chunk from the server 111. It should be appreciated that the local machine 110 will extract the location of the primary chunk from the key vault. As such, the request from the local machine 110 to the server 111 is not specific to the primary chunk, but is just a request from the local machine 110 to the server 111 as with any data chunk on the system and the server 111 is not aware of the specific nature of the chunk which is being served. The server 111 will then serve up the requested primary chunk at 508, and also notify the local machine 110 and serve up any interim packages on the server 111 which are associated with the account. The local machine will then load the primary chunk and initiate the session of the personal data pool at 509. The local machine 110 will query whether or not any interim packages are present at 510. If interim packages are present, the local machine 110 will progress to rebuild and restore lost data at 512 and as further described with reference to FIG. 7 below.

If no interim packages are present, the local machine 110 will make the database available to the user on the local machine 110 at 511. The local machine 110 will then determine whether the local database operated without connection to the server 111 at 513. If the local database was operated without connection to the server 111, then the local machine 110 will flag this state, trigger the use of the local data chunks on the local machine 110, and upload the local data chunks to the server 111 at 514. It should be appreciated that the local machine 110 may preserve or otherwise save a flag or notification that the database was in use on the local machine 110 while not in connection with the server 111 to trigger the upload of local data chunks to the server 111 at 514. During use of the local machine 110 when not in connection with the server 111, the local machine 110 may use cache copies of the key vault and primary chunk as authentication to work on any data chunks present in the local machine 110 cache. The server 111 will then receive the updated local data chunks and store them on the server at 515. If the local database was used without connection to the server 111, then the local data chunks would be used to populate the local database at 516.

Still referring to FIG. 5, if the database did not operate without connection to the server 111, the local machine 110 will begin to populate the local database at 516. The local machine 110 may query whether or not the user has engaged in an action that requires, or requested a particular piece of data that triggers the need for that data chunk at 517. If no user action or trigger is present, the personal data pool will continue with automated population of the database at 516. If the local machine 110 detects an action which does trigger the need for a particular data chunk, then the local machine 110 will request that data chunk, based on the location of that data as held within the prime chunk, at 523. The server 111 will then provide and serve up the requested data chunk at 525. Upon receipt, the local machine 110 may then decrypt the requested data chunk at 526, load the data chunk into the active local database at 527, and update the user interface at 528.

The local machine 110 may continue to populate the local database and request the mandatory data chunks and any secondary chunks at 516 from the server 111 based on established chunking rules at 518. It should be appreciated that the chunking rules for any particular implementation of the personal data pool, payload software, or both may be set as desired or required for that particular implementation. For example, in certain embodiments, the implementation of the personal data pool may assign certain data chunks as mandatory in that they must be present for the function of the personal data pool. The user, personal data pool software, or any applicable payload software may also define data contained within data chunks as optional, may assign a priority category to certain data or data chunks, and may group data chunks based on either horizontal or vertical chunking of the database data. Additional methods for assigning priority to data chunks within the personal data pool may be used and may be defined by the specific needs of a particular embodiment of the personal data pool, any applicable payload software, or both. It should be appreciated that the listing of data chunks, their contents, priority, or other information regarding the connection of data located within specific data chunks on the personal data pool may be contained within the prime chunk that is decrypted on the local machine 110 such that the local machine 110 may request the required data chunks from the server 111 by communicating the location or global unique identifier of the required data chunks without the server 111 requiring any additional information which may allow an unauthorized user to potentially infer the type or content of data held within the data chunks and on the personal data pool.

The local machine 110 may then request the mandatory data chunks and the checksums of the additional data chunks that will be requested of the server 111 at 519. The server 111 may then serve up the mandatory data chunks and the checksums of the server copy of the additional requested data chunks at 520. Upon receipt, the local machine 110 may then check the checksums of the requested data chunks provided by the server 111 with the checksums of the corresponding local copies of the data chunks at 521. The local machine 110 may then query whether the local data chunk checksum matches the checksum of the data chunk provided by the server 111 at 522. If the local data chunk checksum does not match the server 111 provided data chunk checksum, then the local machine 110 may request that data chunk from the server 111 at 523. The server 111 may then serve up the requested data chunk at 525. Upon receipt, the local machine 110 may decrypt the data chunk at 526, load the decrypted data chunk into the local active database at 527, and update the user interface at 528. If, however, the local data chunk checksum matches the checksum of the corresponding data chunk on the server 111, then the local machine may 110 use the local data chunk at 524. The local machine 110 may then load the local data chunk into the active database at 527 and update the user interface at 528.

It should be appreciated that the process of comparing the checksums of local copies of data chunks with the checksums of corresponding data chunks on the server 111 may be used at any point in the personal data pool to allow the local machine 110 to ensure that it has the most current version of a data chunk without requiring the additional bandwidth or time delay of downloading the required data chunk in the case that the most current version of the data chunk already exists on the local machine 110.

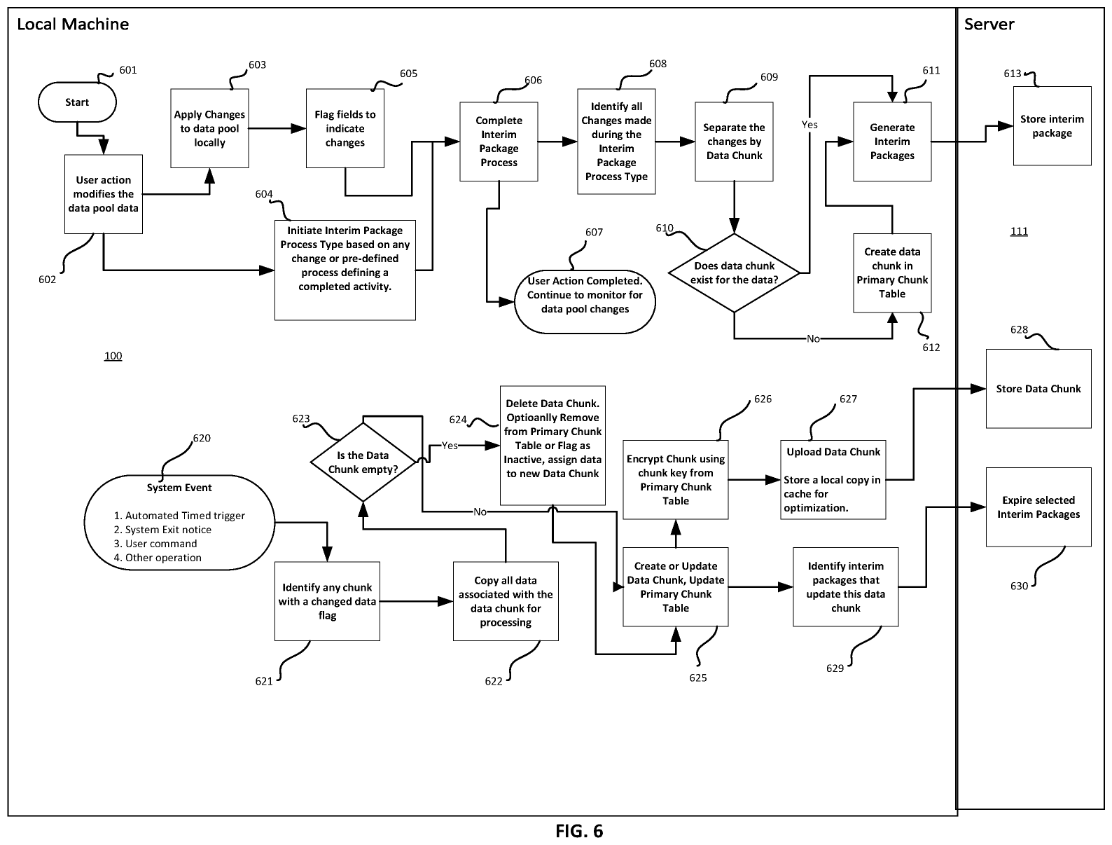

FIG. 6 provides a flowchart of an exemplary embodiment of a method for updating the personal data pool and the interaction between a local machine 110 and a server 111. The process for updating the personal data pool may be initiated with a command or other starting trigger at 601. The local machine 110 may receive a user action or action from any applicable payload software that modifies the data within the data pool at 602. The local machine 110 may then apply the changes to the data pool locally at 603 and flag the appropriate fields to indicate the changes made at 605. The local machine may also initiate an interim package process at 604 based on any change or predefined process that defines a completed activity. It should be appreciated that the interim package process type may be any action that may be used to define a recovery point in the data stream of the data pool. This particular action may be defined as required for a particular implementation of the data pool and should define a point at which the data within the data pool may be recovered.

As the local machine 110 continues to apply changes to the data pool at 603 and flag fields for indicated changes at 605, the local machine 110 may complete the interim package process at 606. From this point, the local machine 110 may continue to monitor the data pool for additional data pool changes at 607 and identify all the changes made during this interim package process at 608. The local machine 110 may then separate the changes that have been made to the data pool by which data chunk each of those respective changes is applied to at 609. After the changes made to the data pool have been assigned to a particular data chunk in the data pool, the local machine 110 may then query at 610 whether a data chunk already exists for each the recorded data changes at 609. If a data chunk exists for a particular recorded data change at 609, then the local machine 110 may generate an interim package at 611 and upload it to the server 111, which may then store the interim package at 613. If, however, there does not exist a data chunk for a particular recorded data change at 609, then the local machine 110 may create a data chunk and update the primary chunk table with the global unique identifier, location of that data chunk, and encryption key for that data chunk at 612. The local machine 110 may then progress to generating the interim package for that data chunk at 611 and uploading to the server 111 where the interim package may be stored at 613. It should be appreciated that this process for generating interim packages may run continuously on the local machine 110 and create an audit trail of interim packages to record changes made to the data pool without any data chunks being uploaded from the local machine 110 to the server 111.

Still referring to FIG. 6, the local machine 110 may also run a process for updating the server 111 with updated data chunks at certain defined or requested points in the operation of the data pool. The process for updating the server 111 with new data chunks may be initiated by a system event 620 which triggers the local machine 110 to generate and upload new data chunk versions. It should be appreciated that the process for generating and uploading data chunks may be triggered on the local machine 110 by a variety of triggers or defined initiation points. For example, the trigger for the data chunk upload process may be an automated time trigger, wherein the time between triggers or a specific time of day may be used as the trigger for the upload of data packages, it may be a system exit notice that the user has exited the data pool or the payload software which works with the data pool. The data chunk upload process may also be triggered by a received user command to begin uploading data chunks to the server 111. The trigger for the data chunk upload process may take on further actions, commands, or responses to conditions in the work environment as required by a particular implementation of the data pool, the payload software which works with the data pool, or hardware considerations such as a lack of available computer memory, storage, processing power, or battery life.

Once the data chunk upload process is triggered at 620, the local machine 110 may then identify any chunk which has been flagged with changed data at 621 and copy all data associated with that data chunk at 622. The local machine 110 may then query whether a particular data chunk is empty or devoid of data at 623. If the data chunk is empty, the local machine 110 may delete the data chunk, flag the data chunk as inactive or optionally remove it from the registry in the primary chunk, assign any applicable data to a new data chunk, reassess linking information between data chunks, or any combination thereof at 624. For data that has been assigned to a new data chunk, the local machine 110 may create a new chunk and update the primary chunk tables to reflect the addition of the new chunk at 625 and encrypt the data chunk using the appropriate data chunk encryption key from the primary chunk at 626. The local machine 110 may then identify all interim packages that are associated with the new or updated data chunk and any deleted data chunks at 629 and send this information to the server 111, wherein the server 111 may expire and delete the identified interim packages at 630. If, however, the data chunk does contain data at 623, then the local machine 110 may update the data chunk and update the primary chunk table to reflect these updates at 625. The local machine 110 may then identify all interim packages that are associated with the updated data chunk at 629 and send this information to the server 111, wherein the server 111 may expire and delete the identified interim packages at 630. The updated or newly created data chunks at 626 may then be uploaded from the local machine 110 to the server 111 at 627, and the server 111 may store the data chunk at 628. It should be appreciated that the local machine may also store a local version of the data chunk at 627 to allow the data pool to continue to use and work on this chunk or save it for a subsequent instance of running the data pool on the local machine 110 and reduce the required bandwidth and data transfer between the local machine 110 and the server 111.

FIG. 7 provides a flowchart of an exemplary embodiment of a method for rebuilding lost data in a personal data pool on a local machine after a loss of connection with a server wherein the server had received one or more interim packages but did not receive all updated data chunks from the local machine.

The rebuild process may be initiated at 701 by any number of methods including the receipt of a request from a user, a signal from the payload software that works with the data pool, or from the data pool system itself during the startup procedures as described in reference to FIG. 5 above. Upon initiation, the local machine will receive a list of all active interim packages present on the server at 702 and use the key vault to locate the global unique identifier of the primary chunk and acquire the list of data chunk global unique identifiers at 703. The local machine may then decrypt all the interim packages at 704, as the interim packages are encrypted with the same encryption key as for the data chunk which any interim package is associated with.

The rebuilding process must now identify the interim package chain and place the interim packages in order to rebuild any data changes that were recorded on the server with interim packages but not with data chunks. This process may start when the local machine selects an interim package at random at 705. The local machine will then identify the chain of interim packages by using the internal listings of global interim package checksums at 706. It should be appreciated that each interim package, as shown with reference to FIG. 3D above, contains a data field that records the checksum of the interim package that was generated before the instant interim package, regardless of the data chunk that the previous interim package was associated with. This record of the previous global interim package checksum allows the local machine to place the interim packages that were served up at 702 into order.

Still referring to FIG. 7, the local machine will check the first, randomly chosen interim package for a previous global interim package checksum at 707. If there is a previous global interim package checksum, then the local machine may query at 708 whether or not an interim package with that checksum exists within the group of interim packages served up at 702. If an interim package with that checksum does exist, then the local machine should select that new interim package at 709 and return to 706 and apply the same steps to the newly chosen interim package, continuing the process until it locates an interim package that does not have a previous global interim package checksum at 707. If no global interim package checksum is present at 707, then the local machine may mark the chain of interim packages as valid at 711 and mark them for processing. If, during the process of checking interim packages the local machine determines that an interim package references a global interim package checksum at 707 which does not correspond to an interim package at 708, then the local machine may record that the interim package chain is broken and mark any package in the previous chain as invalid for processing at 710.

The local machine may continue to iterate through this process of checking interim packages and their associated global interim package checksum fields. The local machine may query at 712 whether all available interim packages have been marked. If not all interim packages have been marked, then the local machine should return to 705, select another interim package at random and continue to iterate. If all interim packages have been marked at 712, then the local machine may progress to 713 and query whether all interim package chains have been verified. If the chains have not been verified, the local machine should drop any broken chains at 715 and not apply any interim packages associated with a broken chain. The local machine may then alert the user to lost data and describe the lost data with the interim package process type field at 716. Once the broken chains have been eliminated at 715, all valid interim packages may be applied to the data pool at 714. Similarly, if all interim package chains have been verified at 713, then all interim package chains may be applied to the data pool at 714.

Next, the local machine may query whether the data chunk checksum field within an interim package matches the checksum of the data chunk with the global unique identifier that is associated with the interim package at 717. It should be appreciated that the checksum of the data chunk represents the version history of the data chunk, and that the data chunk checksum field within the interim package may be used to ensure that the interim package is applied to the correct version of its corresponding data chunk. If the interim package data chunk checksum field does match the current version of the data chunk with a global unique identifier matching the chunk global unique identifier field in the interim package, then the data pool should identify all previous interim packages for this data chunk, using the checksum of the previous interim package in chunk chain field in the interim package and apply these interim packages to the data chunk at 718. It should be appreciated that the interim packages must be applied in the order described by the data chunk interim package chain, beginning with the interim package that has no previous interim package checksum. If the data chunk checksum does not match the interim package data chunk checksum field in the corresponding interim package, the local machine should determine if there is a previously applied interim package in the chain of interim packages for that data chunk. If there is, then the local machine should proceed applying interim packages from the point of the interim package in the data chunk interim package chain with an interim package data chunk checksum field that matches the data chunk checksum and proceed to apply later interim packages in order by using the checksum of the previous interim package in data chunk chain field. If no previously applied interim package is found, then the data chunk interim package chain is broken and processing of interim packages should stop. The data pool may then force a global data pool synchronization event at 720 to synchronize the data on the local machine and the server.

Still referring to FIG. 7, if the interim package data chunk checksum field does not match the checksum of the current version of the data chunk with a matching global unique identifier at 717, then the data pool should not apply these interim packages with mismatched data chunk checksum and interim package data chunk checksum fields at 719 as these interim packages are obsolete. The data pool should then force a global data pool synchronization at 720 between the local machine and the server. The data pool may then move to startup at 721.

Once the global data pool synchronization has been initiated at 720, the local machine may start the global synchronization at 731. The local machine will send all local data chunks to the server to update the server data chunks at 732, and the server will expire all interim packages on the server 733 and clear the server interim package chain at 734. The global synchronization may then stop at 735.

It should be appreciated that the function of the subroutine described with respect to FIG. 7 is to synchronize the local database with the server database while minimizing the loss of data. In the case of an unexpected shutdown or disconnection of the local machine from the server, the server interim package chain will maintain an audit log of changes made to the database data prior to the shutdown or disconnection. However, the local machine may continue to update the local instance of the database and may update data chunks making interim packages on the server obsolete and unnecessary during the rebuild of data. The initial logic loop pertaining to steps 705 to 712 function to place all interim packages that were stored on the server into a global order and detect any breaks in the interim package chain that may indicate lost data that cannot be recovered. Those interim packages are then checked against the data chunks which match the global unique identifier field for the interim package. If an interim package associated with a data chunk contains a value for the data chunk checksum that does not match the checksum of the current version of the data chunk, then the data pool may recognize that the local copy of the data chunk cannot be updated with these interim packages and they must be discarded without update. However, if the data chunk checksum field of the interim package does match the checksum of the current version of a data chunk, then that data chunk may be updated with that interim package to recover data changes. It should be appreciated that the interim packages must be applied in the order described by the data chunk interim package chain, beginning with the interim package that has no previous interim package checksum. If the data chunk checksum does not match the interim package data chunk checksum field in the corresponding interim package, the local machine should determine if there is a previously applied interim package in the chain of interim packages for that data chunk. If there is, then the local machine should proceed applying interim packages from the point of the interim package in the data chunk interim package chain with an interim package data chunk checksum field that matches the data chunk checksum and proceed to apply later interim packages in order by using the checksum of the previous interim package in data chunk chain field. If no previously applied interim package is found, then the data chunk interim package chain is broken and processing of interim packages should stop. In either case, the overall data pool will be brought into a consistent state while minimizing the potential loss of data.

Referring to FIGS. 2A-7, the methods of implementing the personal data pool may employ a computer-readable medium storing integrated circuit instructions that, when executed by an integrated circuit, cause the integrated circuit to carry out the described actions. Furthermore, it should be appreciated that the subroutines of FIGS. 4-7 and the data structures of FIGS. 3A-3D comprise parts of the overall data pool system of FIGS. 2A and 2B.

Referring to FIGS. 1-7, it should be appreciated that while the data pool is herein described with reference to a single local machine and one or more servers, the system and processes described herein may be applied to data pools with multiple users or different structures or arrangements of electronic hardware. Moreover, the data pool system may function as a completely automated system receiving triggers from payload software or other integrated hardware or software systems without the need for a user or other human interaction.

In summary, while the present invention has been described with respect to specific embodiments, many modifications, variations, alterations, substitutions, and equivalents will be apparent to those skilled in the art. The present invention is not to be limited in scope by any of the specific embodiments described herein. Indeed, various modifications of the present invention, in addition to those described herein, will be apparent to those of skill in the art from the foregoing description and accompanying drawings. Accordingly, the invention is to be considered as limited only by the spirit and scope of the following claims, including all modifications and equivalents.

It should be appreciated that any element, part, section, subsection, or component described with reference to any specific embodiment above may be incorporated with, integrated into, or otherwise adapted for use with any other embodiment described herein unless specifically noted otherwise or if it should render the embodiment device nonfunctional. Likewise, any step described with reference to a particular method or process may be integrated, incorporated, or otherwise combined with other methods or processes described herein unless specifically stated otherwise or if it should render the embodiment method nonfunctional. Furthermore, multiple embodiment devices or embodiment methods may be combined, incorporated, or otherwise integrated into one another to construct or develop further embodiments of the invention described herein.

Still other embodiments will become readily apparent to those skilled in this art from reading the above-recited detailed description and drawings of certain exemplary embodiments. It should be understood that numerous variations, modifications, and additional embodiments are possible, and accordingly, all such variations, modifications, and embodiments are to be regarded as being within the spirit and scope of this application. For example, regardless of the content of any portion (e.g., title, field, background, summary, abstract, drawing figure, etc.) of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Further, any activity or element can be excluded, the sequence of activities can vary, and/or the interrelationship of elements can vary. Unless clearly specified to the contrary, there is no requirement for any particular described or illustrated activity or element, any particular sequence or such activities, any particular size, speed, material, dimension or frequency, or any particular interrelationship of such elements. Accordingly, the descriptions and drawings are to be regarded as illustrative in nature, and not as restrictive. Moreover, when any number or range is described herein, unless clearly stated otherwise, that number or range is approximate. When any range is described herein, unless clearly stated otherwise, that range includes all values therein and all sub ranges therein. Any information in any material (e.g., a United States/foreign patent, United States/foreign patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such incorporated by reference material is specifically not incorporated by reference herein.

I claim:

1. An encrypted database system comprising:
at least one local machine in communication with at least one server;
wherein said at least one local machine receives electronic data and divides said electronic data into one or more data chunks, said at least one local machine receives a primary chunk encryption key and a key vault encryption key, generates a primary chunk comprising a database schema, a table of global unique identifiers for said one or more data chunks, and a table of encryption keys for said one or more data chunks, generates a key vault comprising a primary chunk global unique identifier field, a primary chunk encryption key field, and a primary chunk location field, and said at least one local machine encrypts said one or more data chunks, encrypts said primary chunk with said primary chunk encryption key, encrypts said key vault with said key vault encryption key, and uploads said one or more data chunks, said primary chunk, and said key vault to said at least one server; and
wherein said local machine generates an interim package when a change process is applied to at least one of said one or more data chunks, encrypts said interim package, and uploads said interim package to said at least one server; and
wherein said at least one server receives and stores said primary chunk, said key vault, said one or more data chunks, and said interim package.

2. A method of database management comprising:
processing data into one or more data chunks;
receiving a primary chunk encryption key and a key vault encryption key;
generating a primary chunk comprising a database schema, a table of global unique identifiers, and a table of encryption keys;
generating a key vault comprising a primary chunk global unique identifier field, a primary chunk encryption key field, and a primary chunk location field;
populating said table of global unique identifiers with at least one global unique identifier associated with said one or more data chunks;
populating said table of encryption keys with at least one encryption key associated with said one or more data chunks;
populating said primary chunk global unique identifier field of said key vault, said primary chunk encryption key field, and said primary chunk location field;
encrypting said one or more data chunks, said primary chunk, and said key vault;
uploading said one or more data chunks, said primary chunk, and said key vault to a server; and
generating one or more interim packages when a change process completes on at least one of said one or more data chunks, encrypting said one or more interim packages, and uploading said one or more interim packages to a server.

3. At least one computer-readable storage medium having instructions recorded thereon which, when executed by a computer, cause the computer to perform a method for operating an encrypted database, the method comprising:
processing data into one or more data chunks;
receiving a primary chunk encryption key and a key vault encryption key;
generating a primary chunk comprising a database schema, a table of global unique identifiers, and a table of encryption keys;
generating a key vault comprising a primary chunk global unique identifier field, a primary chunk encryption key field, and a primary chunk location field;
populating said table of global unique identifiers with at least one global unique identifier associated with said one or more data chunks;
populating said table of encryption keys with at least one encryption key associated with said one or more data chunks;
populating said primary chunk global unique identifier field of said key vault, said primary chunk encryption key field, and said primary chunk location field;
encrypting said one or more data chunks, said primary chunk, and said key vault;
uploading said one or more data chunks, said primary chunk, and said key vault to a server; and
generating one or more interim packages when a change process completes on at least one of said one or more data chunks, encrypting said one or more interim packages, and uploading said one or more interim packages to a server.
